(19) United States
(12) Patent Application Publication
(10) Pub. No.: US 2007/0199744 A1
(43) Pub. Date: Aug. 30, 2007

(54) Power generating and storage system having a common stator

(76) Inventor: Scott A. Leman, Eureka, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/363,233

(22) Filed: Feb. 28, 2006

(51) Int. Cl. B60K 6/00

(52) U.S. Cl. 180/65.2

(57) ABSTRACT

A power system for a mobile vehicle is disclosed. The power system has a power source, a first rotor mechanically driven by the power source, and a second rotor rotationally decoupled from the power source. The power system also has a stator common to the first and second rotors.

### TECHNICAL FIELD

The present disclosure relates generally to a power system and, more particularly, to a hybrid power system having a motor/generator, a power storage device, and a common stator.

### BACKGROUND

Machines, including vocational vehicles, off-highway haul trucks, motor graders, wheel loaders, and other types of heavy machinery are used for a variety of tasks. These machines often include a generator coupled to an engine such as, for example, a diesel engine, a gasoline engine, or a gaseous fuel-powered engine. The engine mechanically drives the generator to produce electrical power, which may be used to propel the machine, power accessory loads of the machine, and/or drive one or more work implements associated with the machine. A power load placed on the generator by a traction device, accessory equipment, or the work implement is transmitted in reverse direction to the engine. Power load changes, either requiring additional power or less power, can cause the engine to deviate from a desired operating range. Deviations from the desired operating range result in poor efficiency, lower production, increased wear on the engine, and operator dissatisfaction.

Machines typically include a flywheel to help minimize variations in engine speed caused by a change in the power load. The magnitude of the speed changes may be minimized by increasing the inertia of the flywheel. However, as flywheel inertia increases, engine responsiveness decreases. A conventional flywheel may be inefficient at providing a balance between minimizing engine speed fluctuations and allowing the engine to respond quickly to desired power changes.

In an attempt to provide a flywheel offering improved responsiveness to a wide range of load changes, an electric flywheel has been proposed. In particular, U.S. Pat. No. 6,891,279 (the '279 patent) issued to Kazama on May 10, 2005, describes a hybrid vehicle having an electric power generator, an electric power storage unit, and a vehicle drive motor driven by electric power output supplied from at least one of the electric power generator and the electric power storage unit. The electric power storage unit is separate from the electric power generator and composed of a flywheel coupled to an electric motor generator to store electric power as rotational energy. The stored electric power may then be used to drive the vehicle motor during situations in which power from the electric power generator is insufficient to meet power demands of the vehicle drive motor.

While, the electric power storage unit of the '279 patent may offer improved responsiveness to a range of load changes, it may be expensive and bulky. In particular, because the electric power generator and electric power storage unit are separate from each other, they may require duplicate electronic components. These duplicate components may increase the cost of the hybrid vehicle and reduce available space within the vehicle.

The power system of the present disclosure solves one or more of the problems set forth above.

### SUMMARY OF THE INVENTION

In one aspect, the present disclosure is directed to a power system. The power system includes a power source, a first rotor mechanically driven by the power source, and a second rotor rotationally decoupled from the power source. The power system also includes a stator common to the first and second rotors.

In another aspect, the present disclosure is directed to a mobile vehicle. The mobile vehicle includes an engine and a stator operatively mechanically connected to the engine. The mobile vehicle also includes a first rotor mechanically driven by the engine to interact with the stator and produce electrical power, a traction device operatively driven by the electrical power to propel the mobile vehicle, and a second rotor configured to interact with the stator and store and release power rotationally.

### BRIEF DESCRIPTION OF THE DRAWINGS

FIG. 1 is a diagrammatic illustration of an exemplary disclosed mobile vehicle; and

FIG. 2 is a diagrammatic illustration of a power system for use with the vehicle of FIG. 1.

### DETAILED DESCRIPTION

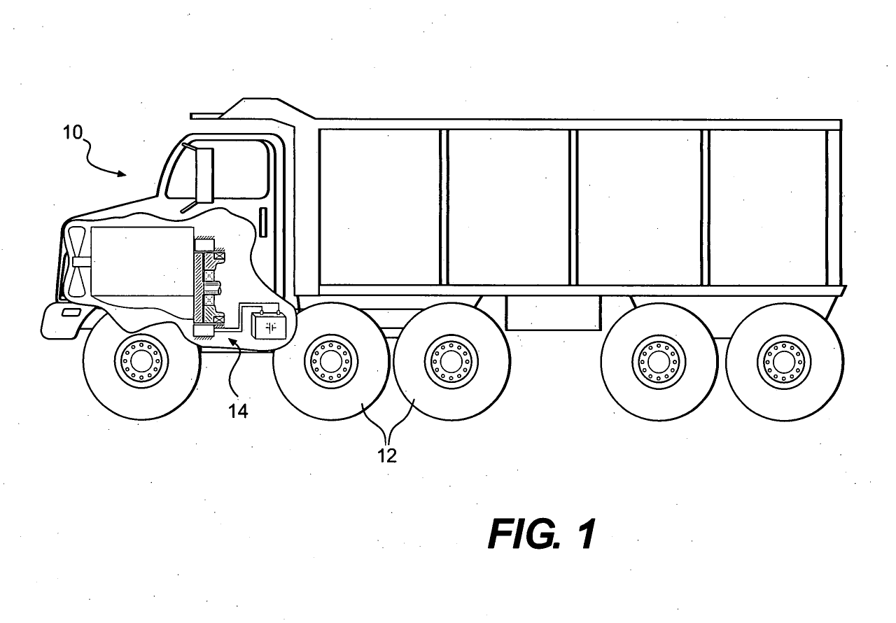

FIG. 1 illustrates an exemplary embodiment of a machine 10. Machine 10 may embody a mobile vehicle configured to perform some type of operation associated with an industry such as transportation, mining, construction, farming, or any other industry known in the art. For example, machine 10 may be an earth moving machine such as a haul truck, a wheel loader, a backhoe, a motor grader, or any other suitable operation-performing machine. Machine 10 may include at least one traction device 12 driven by a power system 14.

Traction device 12 may include wheels located on each side of machine 10 (only one side shown). Alternately, traction device 12 may include tracks, belts or other known traction devices. It is contemplated that any of the wheels on machine 10 may be driven and/or steered.

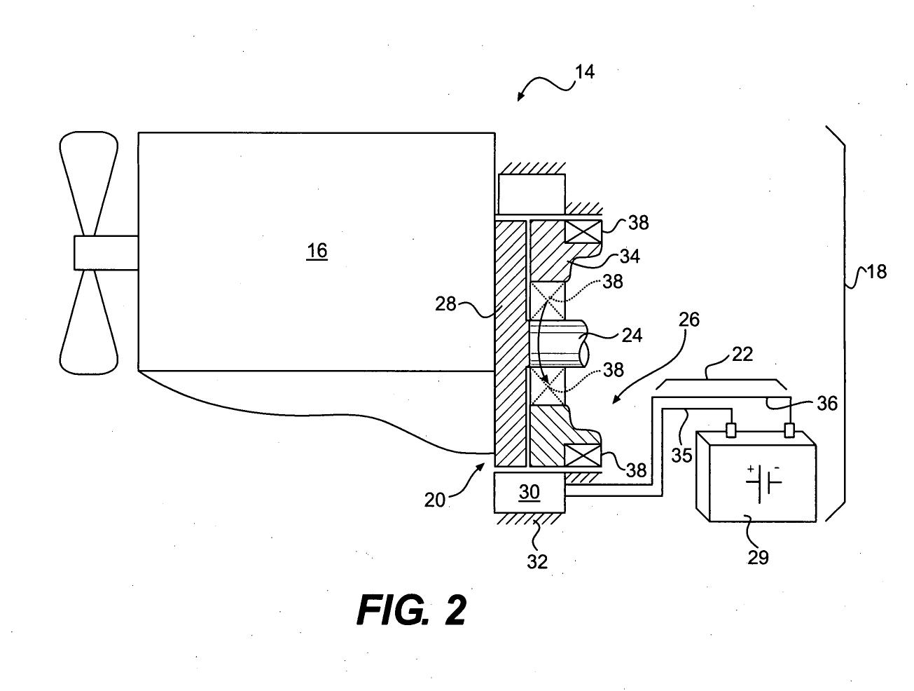

As illustrated in FIG. 2, power system 14 may include an engine 16 such as, for example, a diesel engine, a gasoline engine, a gaseous fuel powered engine such as a natural gas engine, or any other type of engine apparent to one skilled in the art. Power system 14 may alternatively include a non-combustion source of power such as a fuel cell, a power storage device, an electric motor, or other similar mechanism. Engine 16 may be connected to drive traction device 12 via an electric drive 18, thereby propelling machine 10.

Electric drive 18 may include components that cooperate to covert a mechanical power output of engine 16 to electrical power used to propel machine 10. For example, electric drive 18 may include a motor/generator 20 rotatable to produce an electrical power output directed to a common bus 22 and electrically drivable to mechanically rotate an output shaft 24. Electric drive 18 may also include a power storage device 26 configured to draw power from and release power to common bus 22. It is contemplated that electric drive 18 may further include an electrically driven motor (not shown) operatively connected to draw power from common bus 22 and propel traction device 12; a controller (not shown) in communication with the drive motor, motor/generator 20, and power storage device 26; a resistive grid circuit (not shown) configured to burn off excess power from common bus 22; additional storage devices such as a battery 29 or a capacitor bank (not shown), and other similar drive components known in the art.

Motor/generator 20 may be a single unit configured to selectively operate as a motor by applying torque to engine 16, or as a generator driven by engine 16 to produce electrical power. Specifically, motor/generator 20 may include a rotor 28 rotatable within a fixed external stator 30. Electrical current may be sequentially applied to windings (not shown) of stator 30 to generate a rotating magnetic field that urges rotor 28 to rotate output shaft 24. Conversely, as rotor 28 is rotationally driven within stator 30 by engine 16, electrical current may be induced within the windings of stator 30. Rotor 28 may be fixedly connected to output shaft 24 such that an output rotation of output shaft 24 results in a corresponding rotation of rotor 28. Stator 30 may be operatively fixed to engine 16 by way of a mount 32. Mount 32 may be directly connected to engine 16 or, alternatively, indirectly connected to engine 16 by way of an engine housing (not shown).

Common bus 22 may include positive and negative power lines 35, 36 that electrically connect motor/generator 20, power storage device 26, battery 29, the capacitor, the resistive grid circuit, and other components to the drive motor. Common bus 22 may also be electrically connected to accessory power loads (not shown) that remove power from common bus 22.

Power storage device 26, also referred to as an electric flywheel, may include components that function to store and release energy rotationally. In particular, power storage device 26 may include a rotor 34 rotatable within stator 30 (e.g., stator 30 may be common to both rotor 28 and rotor 34). Electrical current may be sequentially applied to windings of stator 30 to generate a rotating magnetic field that urges rotor 34 to rotate. Rotor 34 may be of substantial inertial mass (e.g., having an inertial mass greater than that of rotor 28) and remain in motion for a considerable length of time once motion has been initiated. As rotor 34 rotates within stator 30, the rotational movement of rotor 34 may be used to induce electrical current in the windings of stator 30. Rotor 34 may rotate independent of output shaft 24 such that an output rotation of output shaft 24 has little or no affect on the rotation of rotor 34 and visa versa. Rotor 34 may be supported by one or more bearings 38 and mounted to engine 16 either directly or indirectly by way of mount 32. Although bearings 38 are illustrated as being located radially external to rotor 34, it is contemplated that bearings 38 may alternatively be located radially internal to rotor 34 between rotor 34 and output shaft 24, if desired.

### INDUSTRIAL APPLICABILITY

The disclosed system may be applicable to any power system that requires dampening and/or storage of power loads to minimize or prevent performance deviations outside of a desired operating range. For purposes of this disclosure, the term “desired operating range” includes those operating conditions that the machine operator and/or machine control system wants to achieve and/or maintain such as, for example, engine speed. Deviations from this desired operating range may result in increased fuel consumption, increased exhaust emissions, increased engine temperatures, decreased machine productivity, operator dissatisfaction, and/or decreased responsiveness.

Deviations from the desired operating range may be experienced when sudden changes in power load experienced by traction device 12 are transferred by electric drive 18 or other engine powered devices to engine 16. Machine 10 may utilize power storage device 26 to dampen sudden changes. For example, during a sharp reduction in power loading, excess power generated by motor/generator 20 may be directed to and absorbed by power storage device 26, resulting in a rotation of rotor 34. In contrast, during a sharp increase in power loading, the rotation of rotor 34 may be used to generate additional power (e.g., power in addition to that generated by motor/generator 20) directed back to drive rotor 28 and output shaft 24 or directed to the drive motor of machine 10. In this manner, power system 14 may enable engine 16 to respond more quickly to a sudden change in power load than if engine 16 included only a traditional flywheel. Power system 14 may, therefore, decrease the likelihood of engine 16 deviating from the desired operating range. In addition, because both the direction of power from motor/generator 20 to power storage device 26 and from power storage device 26 to motor/generator 20 utilize common electronic components (e.g., common stator 30), the cost and space consumed by electric drive 18 may be reduced.

It will be apparent to those skilled in the art that various modifications and variations can be made to the disclosed power system without departing from the scope of the disclosure. Other embodiments of the power system will be apparent to those skilled in the art from consideration of the specification and practice of the power system disclosed herein. It is intended that the specification and examples be considered as exemplary only, with a true scope of the disclosure being indicated by the following claims and their equivalents.

What is claimed is:

1. A power system, comprising:
a power source;
a first rotor mechanically driven by the power source;
a second rotor rotationally decoupled from the power source; and
a stator common to the first and second rotors.

2. The power system of claim 1, wherein the second rotor is a flywheel configured to selectively store and release rotational energy.

3. The power system of claim 2, wherein the inertial mass of the second rotor is greater than the inertial mass of the first rotor.

4. The power system of claim 1, wherein the stator is operatively mechanically connected to the power source.

5. The power system of claim 1, wherein the second rotor is operatively mechanically connected to the power source.

6. The power system of claim 1, wherein the second rotor is operatively electrically driven by the first rotor.

7. The power system of claim 6, wherein the first rotor is operatively electrically driven by the second rotor.

8. A mobile vehicle, comprising:
an engine;
a stator operatively mechanically connected to the engine;
a first rotor mechanically driven by the engine to interact with the stator and produce electrical power;
a traction device operatively driven by the electrical power to propel the mobile vehicle; and
a second rotor configured to interact with the stator and store and release power rotationally.

9. The mobile vehicle of claim 8, wherein the second rotor is rotationally decoupled from the engine.

10. The mobile vehicle of claim 8, wherein the second rotor is a flywheel and has an inertial mass greater than that of the first rotor.

11. The mobile vehicle of claim 8, wherein at least one of the stator and the second rotor is operatively mechanically connected to the power source.

12. The mobile vehicle of claim 8, wherein:
the second rotor is operatively electrically driven by the first rotor; and
the first rotor is operatively electrically driven by the second rotor.
